(19) United States
(12) Patent Application Publication
(10) Pub. No.: US 2015/0203291 A1
(43) Pub. Date: Jul. 23, 2015

(54) Dripless Trash Bag

(71) Applicant: B3 PLASTICS, LLC, Kailua-Kona, HI (US)

(72) Inventors: Tara J. Saville, Kailua Kona, HI (US); Mark D. Sale, Kailua Kona, HI (US); Jay B. Paulson, Waikoloa, HI (US)

(21) Appl. No.: 14/417,148

(22) PCT Filed: Jul. 24, 2013
(86) PCT No.: PCT/US13/51903

§ 371 Date: Jan. 24, 2015

Related U.S. Application Data
(60) Provisional application No. 61/675,279, filed on Jul. 24, 2012.

(51) Int. Cl. B65F 1/00

(52) U.S. Cl. CPC B65F 1/0006; B65F 2210/1023; B65F 2250/114

(57) ABSTRACT

A dripless trash bag formed from flattened material such as plastic sheeting or tubular plastic is configured to absorb liquid waste accumulating therein by means of a perforated transverse retaining weld located between top and the bottom ends of the bag and intermittently sealing front and back sides of the bag. An absorbent material located between the retaining weld and the bottom end may be hydrophilic or hydrophobic, and may be a strip of absorbent material or a liquid-permeable container enclosing an absorbent material such as a desiccant. One or more voids defined in the perforated retaining weld allow passage of liquid through the weld into contact with the absorbent material.

### RELATED APPLICATIONS

This application is a national phase entry of PCT/US2013/051903 filed Jul. 24, 2013, which claims priority to U.S. Provisional Application 61/675,279 filed on Jul. 24, 2012, both of which applications are fully incorporated herein by reference.

### BACKGROUND OF THE INVENTION

1. Field of the Invention

The present invention relates generally to containers, more specifically to plastic bags, and most specifically to plastic bags having an internal absorbent material.

2. Description of Related Art

Trash bags are ubiquitous goods, used throughout many industries, commercial locales, and in the home. Industrial workers use heavy duty plastic trash bags for disposing of many types of waste, generated for example from raw materials used on assembly and manufacturing lines or in the course of working with various materials at constructions sites. Institutional users rely on plastic bags for assisting with the disposal of many types of waste including paper, inks, cleaning supplies, medical waste, food waste, etc. Individual consumers use plastic bags for typical household waste. The waste may be wet, dry, paper, powder, food, biological, etc.

Most consumers know that throwing away liquid waste, or even waste that may only be partially liquid, usually means that the bag needs to be handles carefully or perhaps double-bagged. If the bag rips or is not tied securely enough, the liquid will fid its way to the floor, to the wall, onto carpet, into the cargo area, or to bottom of the trash can. Most manufacturers of plastic bags respond to this problem by making the bag material stronger or more elastic or by reinforcing the seams of the bag. Despite these measures, when liquid is introduced into the bag, even a small tear or tiny puncture will result in leakage of the liquid contents.

While some solutions to this problem have been proposed that involve the use of an absorbent material within the bag, none are well-suited for mass production of consumer grade trash bags, due primarily to the complexity of design. What is needed is an innovation for trash bags that prevents leakage of liquid content while providing a cost-effective design for mass production.

### SUMMARY OF THE INVENTION

The present invention provides an engineered design for a trash bag that contains an absorbent material for discouraging leakage of liquid content. Hereafter, such a design may be referred to as a dripless bag or as a dripless trash bag. The dripless bag is ideally suited for general industrial, commercial, and consumer use.

In one embodiment, a dripless bag according to the invention has a front side and a back side formed from flattened material, an open top, and a bottom sealed by a seam or a fold in the material. The bag is configured with a liquid-absorbing structure that includes a retaining weld located between the top and the bottom and sealing the front side to the back side, and an absorbent material located between the retaining weld and the bottom of the bag. The retaining weld is perforated by one or more voids defined through the retaining weld to allow passage of liquid through the weld into contact with the absorbent material.

In one variation of the invention, the retaining weld runs substantially transversely across the bag in a direction parallel to the sealed bottom. The retaining weld may be formed by heat-sealing, or the weld may be formed by an adhesive. In another variation, the flattened material that comprises the body of the bag may be formed from tubular plastic bag stock, such that the front side and the back side comprise one continuous seamless side.

The absorbent material may be hydrophilic or hydrophobic, and may comprise a strip of absorbent material configured for insertion within the absorbing region defined between the retaining weld and the bottom of the bag. In another embodiment, the absorbent strip may comprise a liquid-permeable container filled with a granular desiccant. In another embodiment, the absorbing region has a volume approximately identical to a volume of the absorbent material located therein, and the plastic material that forms the bag is selected for strength and elasticity sufficient to allow the absorbing region to swell with the absorption of liquid without bursting or leaking.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is frontal perspective view of a dripless trash bag according to one embodiment of the invention.

FIG. 2 is a magnified side view of the dripless trash bag of FIG. 1, showing an absorbent material in a dry state contained within an absorbing region adjacent to the bottom of the bag.

FIG. 3 is a magnified side view of the dripless trash bag of FIG. 1, showing the absorbent material in a wet or saturated state.

FIG. 4 is a front view of another embodiment of a dripless trash bag according to the invention, in which voids are provided at either end of a perforated transverse retaining weld.

FIG. 5 is a front view of another embodiment of a dripless trash bag according to the invention, in which multiple voids are staggered intermittently across the linear location of the perforated transverse weld.

FIG. 6 is a front view of another embodiment of a dripless trash bag according to the invention, in which the top of the bag is provided with a drawstring closer and in which a centrally located void perforates the transverse retaining weld.

FIG. 7 is a front view of another embodiment of a dripless trash bag according to the invention, in which the top of the bag is provided with tie flaps for closing the bag, and in which both corner and central voids are defined in a transverse perforated retaining weld 48.

### DETAILED DESCRIPTION OF THE INVENTION

The following disclosure presents exemplary embodiments for a dripless trash bag according to the present invention. The dripless trash bag is ideally suited for general commercial and consumer usage and for mass production, for example, in rolls of plastic sheet or tubular material on which individual bags may be separated by perforations regularly located along the roll.

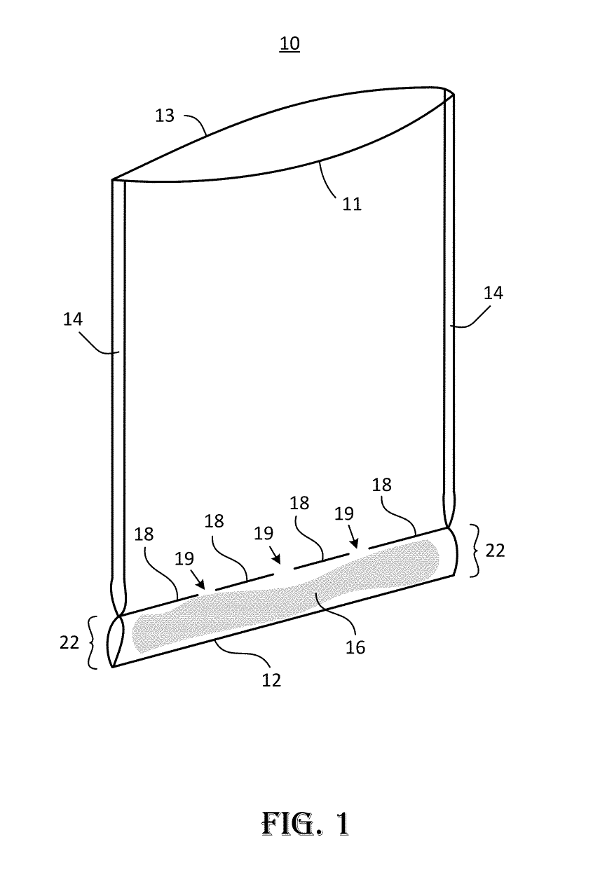

FIG. 1 shows a perspective view of a dripless trash bag 10 having an absorbent strip 16 contained therein. Dripless trash bag 10 may be formed from a layer or layers of a plastic roll that is folded, forming a bottom 12. The front side of the bag 11 and the back side of the bag 13 are held together by side seams or welds such as weld 14 and the top of the bag remains open. The side seams or welds may consist of heat sealed seams, adhesively bonded seams, or another type of manufactured seam known in the art. No limitation to any particular method of sealing the front side to the back side is intended and none should be inferred. Similarly, while the bag shown has a transverse seam or fold forming the bottom 12 of the bag, there is no limitation to this configuration. Typically, manufacturing processes form the bags by means of a bottom fold, however, side folds with welded bottoms are also possible.

In another embodiment, the dripless trash bag 10 may be formed from tubular plastic film, open at the top and bottom ends, in which case welds 14 do not exist. In this embodiment, the tubular stock is flattened to create the front side 11 and back side 13, and welded at bottom seam 12 to form the bag with an open top and closed bottom. Note that in this case, front side 11 and back side 13 are in fact one continuous and seamless side.

Regardless of the manner in which the bottom of the bag is formed, an absorbent strip 16 will reside at or near the bottom 12. In one embodiment of a process for manufacturing a dripless bag 10, the material that forms the absorbent strip is placed at or near the location of the bottom seam or fold 12. The absorbent strip may consist of one or a combination of many types of materials, including air-laid paper, spun lace, or hydroentangled fibers of any type including paper, natural fibers, artificial fibers, and the like. The absorbent strip 16 may be hydrophilic material, or any material that absorbs or reacts with water.

In other embodiments, the absorbent strip 16 may be an oil absorbent, such as the internal material used in oil filters, or an oil or water absorbent clay such as montmorillonite. In another embodiment, the absorbent strip may be a hydrophobic oil absorbent formed, for example, from materials commercially available from the Cary Company of Addison, Ill. In still other embodiments, the absorbent strip may comprise desiccants such as silica gel, activated charcoal, calcium sulfate, calcium chloride, molecular sieves, or absorbent grains or granules such as those found in commercially available cat litter. Where granular material is used, whether hydrophilic or hydrophobic, the strip may comprise a liquid-permeable outer container such as a sock made of net or fabric at least partially filled with the granular material.

The absorbent strip 16 is mechanically held in place near the bottom 12 by a retaining weld 18 running in a generally transverse direction across the bag, i.e., in a direction parallel to the top 13 and bottom 12 borders of the bag. The retaining weld 18 may be formed by heat-sealing two sides of the bag, or it may be formed by use of an adhesive or bonding agent, in which case it is not a weld in the conventional sense, but rather a wall-to wall seam. The retaining weld 18 is shown in FIG. 1 as a series of weld segments, but may be referred to herein as a singular weld. In one embodiment the retaining weld is formed by applying heat to the folded bag, enough to seal the front and back sides together, but without melting through the sides or otherwise compromising or creating holes or voids therethrough.

According to the invention, the retaining weld 18 has at least one void 19 or break in the weld itself that allows liquids within the body of the bag (i.e. that portion of the bag between the open top of the bag and the weld) to run down into the absorbing region 22 between the retaining weld 18 and the bottom fold 12. This configuration, referred to hereafter as a perforated weld or as a partial wall-to-wall seam, allows the liquid to be readily absorbed by the absorbent strip 16 that is installed within the absorbing region 22.

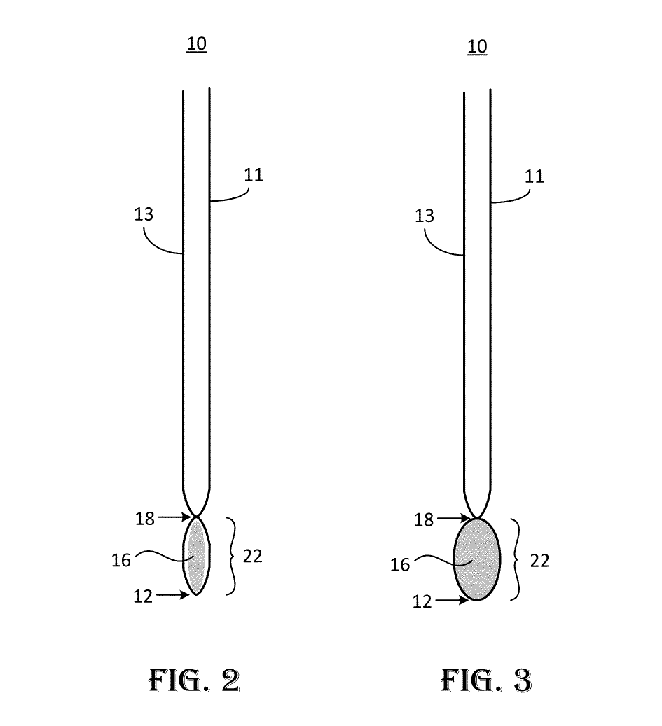

FIGS. 2 and 3 show magnified side views of the dripless bag 10 in which the absorbent strip 16 has been installed. In FIG. 2, the absorbent strip 16 is shown located in the absorbing region between the front side 11 and the back side 13, and between the bottom 12 and the retaining weld 18. The absorbing region 22 should be configured to some degree larger than the volume of a dry absorbent strip 16 to facilitate installation of the absorbent strip, and to allow the absorbent strip to swell with absorbed liquid, to a state of saturation, as shown in FIG. 3, without putting undue strain on the bag, fold, and welds. In one embodiment, the volume of the absorbing region is approximately 2 to 3 times the volume of the absorbent strip when the absorbent strip is dry or substantially free of liquid. In another embodiment, the ratio of the absorbing region to the dry absorbent strip is approximately 1:1, in which case the design relies on the strength and elasticity of bag material to swell with the absorption of liquid without bursting or leaking. Other volume ratios are possible within the scope of the invention.

In an alternative embodiment, in lieu of the retaining weld 18, the absorbent strip 18 may include a line of adhesive that holds the strip 18 in place near the bottom of the bag by adhering to the front side 11 and to the back side 13 along substantially transverse paths. In this embodiment, the line of adhesive material is staggered or intermittent, to create gaps between the front and back sides of the bag that will allow liquid to reach the absorbing region 22.

The absorbent strip 18 can be used in any size bag of any configuration. For example, the dripless bag could be configured for use in household trash cans, wastepaper baskets, or kitchen trash bags, or as a larger outdoor trash bag such as those referred to as lawn and leaf bags. No limitation to any particular size or configuration is intended nor should any such limitation be inferred.

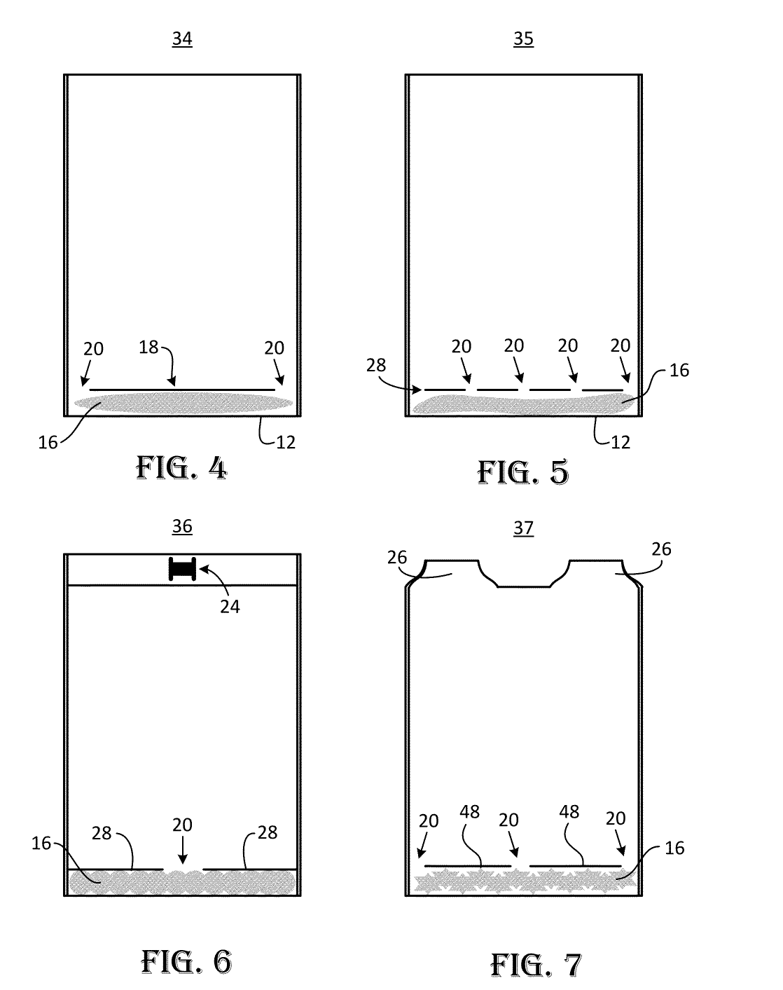

FIGS. 4, 5, 6 and 7 show different types of closure configurations for dripless bags manufactured in accordance with the invention. FIG. 4 shows a flat top dripless bag 34 having a perforated transverse retaining weld 18 and an absorbent strip 16 installed in the absorbing region defined below the weld. The dripless bag 34 is typically closed with a tie (not shown). In this embodiment, the voids 20 are provided at opposite ends of the weld 18.

FIG. 5 shows an embodiment of a dripless bag 35 having an alternative retaining weld 28. The retaining weld 28 is characterized as being substantially parallel to the top and bottom borders of the bag and having multiple voids 20.

FIG. 6 shows an embodiment of a dripless bag 36. In this embodiment, the bag is configured with a drawstring closer 24, and also with a centrally located void 20 that perforates a transverse retaining weld 38.

FIG. 7 shows an embodiment of a dripless bag 37. This embodiment features a means for closing the bag in the form of a tie flaps 26. Bag 37 is also characterized by having corner and a central voids 20 defined in a transverse perforated retaining weld 48, wherein each of the voids 20 perforates the weld.

It should be appreciated that several of the foregoing features and functions, or alternatives thereof, may be combined into many other embodiments that are mere variations on the inventive aspects of the invention. For example, any combination of the various closing means, overall bag sizes, weld numbers, weld positions, weld types, numbers of voids, and types of absorbent materials fall within the scope of the invention. Methods of manufacture may also vary. For example, placement of the absorbent strip with the absorbing are of a bag may occur prior to or after creation of the perforated retaining weld.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A dripless trash bag having a front side and a back side formed from flattened material, an open top, and a bottom sealed by a seam or a fold in the material, the improvement comprising:
a retaining weld located between the top and the bottom and sealing the front side to the back side;
an absorbent material located between the retaining weld and the bottom; and
one or more voids defined in the retaining weld to allow passage of liquid through the weld into contact with the absorbent material.

2. The dripless trash bag of claim 1 wherein the retaining weld run substantially transversely across the bag in a direction parallel to the sealed bottom.

3. The dripless trash bag of claim 1 wherein the retaining weld is formed by an adhesive.

4. The dripless trash bag of claim 1 wherein the flattened material is tubular such that the front side and the back side comprise one continuous seamless side.

5. The dripless trash bag of claim 1 wherein the absorbent material is hydrophilic.

6. The dripless trash bag of claim 1 wherein the absorbent material is hydrophobic.

7. The dripless trash bag of claim 1 wherein the absorbent material comprises a strip of absorbent material.

8. The dripless trash bag of claim 7 wherein the absorbent strip comprises a liquid-permeable container filled with a granular desiccant.

9. The dripless trash bag of claim 1 wherein the retaining weld comprises a transverse partial wall-to-wall seam formed by heat-sealing and having one or more perforations that comprise the one or more voids.

10. The dripless trash bag of claim 1 further comprising an absorbing region located between the retaining weld and the bottom of the bag, the absorbing region having a volume approximately identical to a volume of the absorbent material located therein.
